(19) United States
(12) Patent Application Publication
(10) Pub. No.: US 2016/0357340 A1
(43) Pub. Date: Dec. 8, 2016

(54) Information Processing Method and Electronic Device

(71) Applicant: Huawei Device Co., Ltd., Shenzhen (CN)

(72) Inventors: Bo Ma, Shenzhen (CN); Chao Meng, Shanghai (CN); Yue Wang, Shenzhen (CN)

(73) Assignee: Huawei Device Co., Ltd., Shenzhen (CN)

(21) Appl. No.: 15/038,816

(22) PCT Filed: Nov. 25, 2013
(86) PCT No.: PCT/CN2013/087771

§ 371 Date: May 24, 2016

(51) Int. Cl. G06F 3/041; G06F 3/044

(52) U.S. Cl. CPC G06F 3/0418; G06F 3/044

(57) ABSTRACT

An information processing method and an electronic device, so as to resolve a technical problem in the prior art, with an electronic device configured with a capacitive touchscreen, that the electronic device cannot recognize a finger touch region of a user when there is water on a surface of the capacitive touchscreen is presented. The method in the present disclosure includes acquiring a current capacitance corresponding to each sensing point on a capacitive touchscreen of an electronic device; separately subtracting a preset capacitance from the current capacitance corresponding to each sensing point to obtain a capacitance difference corresponding to each sensing point; and determining, according to the capacitance difference corresponding to each sensing point, a touch region on which a finger touch operation on the capacitive touchscreen acts.

### CROSS-REFERENCE TO RELATED APPLICATIONS

This application is a National Stage of International Application No. PCT/CN2013/087771, filed on Nov. 25,2013, which is hereby incorporated by reference in its entirety.

### TECHNICAL FIELD

The present disclosure relates to the field of electronic technologies, and in particular, to an information processing method and an electronic device.

### BACKGROUND

As technologies develop, a capacitive touchscreen has become a standard configuration of many electronic devices (such as smartphones and tablet computers). The capacitive touchscreen is not only a display apparatus, but also an input apparatus, which can detect a finger touch region of a user and make a corresponding response.

In a current electronic device configured with a capacitive touchscreen, water is not allowed on a surface of the capacitive touchscreen. If there is water on the surface, the electronic device cannot recognize a finger touch region of a user, so that the user cannot normally use the capacitive touchscreen to perform a touch operation.

### SUMMARY

The present disclosure provides an information processing method and an electronic device, so as to resolve a technical problem in the prior art, with an electronic device configured with a capacitive touchscreen, that the electronic device cannot recognize a finger touch region of a user when there is water on a surface of the capacitive touchscreen.

According to a first aspect, an information processing method is provided, including acquiring a current capacitance corresponding to each sensing point on a capacitive touchscreen of an electronic device; separately subtracting a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen; and determining, according to the capacitance difference corresponding to each sensing point, a touch region on which a finger touch operation on the capacitive touchscreen acts.

With reference to the first aspect, in a first possible implementation manner, the determining, according to the capacitance difference corresponding to each sensing point, a touch region on which a finger touch operation on the capacitive touchscreen acts includes determining a sensing region that is formed by sensing points whose capacitance difference is a negative value among all the sensing points as a first sensing region; determining a sensing region that is formed by sensing points whose capacitance difference is a positive value among all the sensing points as a second sensing region; and determining, according to a location relationship between the first sensing region and the second sensing region, the touch region on which the finger touch operation on the capacitive touchscreen acts.

With reference to the first possible implementation manner of the first aspect, in a second possible implementation manner, the determining, according to a location relationship between the first sensing region and the second sensing region, the touch region on which the finger touch operation on the capacitive touchscreen acts includes, if the first sensing region and the second sensing region are not connected, determining the first sensing region as the touch region on which the finger touch operation acts; and/or if the first sensing region and the second sensing region are connected and the first sensing region is surrounded by the second sensing region, determining a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

With reference to the first possible implementation manner of the first aspect, or the second possible implementation manner of the first aspect, in a third possible implementation manner, the method further includes determining the second sensing region as a water-covered region.

With reference to the first possible implementation manner of the first aspect, or the second possible implementation manner of the first aspect, or the third possible implementation manner of the first aspect, in a fourth possible implementation manner, the method further includes acquiring an area of the second sensing region; and controlling the electronic device to power off when the area of the second sensing region is larger than a preset area.

Based on a same disclosure concept, according to a second aspect, an electronic device is provided, including a first acquiring unit configured to acquire a current capacitance corresponding to each sensing point on a capacitive touchscreen of the electronic device; a computing unit configured to receive the current capacitance corresponding to each sensing point from the first acquiring unit, and separately subtracting a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen; and a first determining unit configured to receive the capacitance difference corresponding to each sensing point from the computing unit, and determine, according to the capacitance difference corresponding to each sensing point, a touch region on which a finger touch operation on the capacitive touchscreen acts.

With reference to the second aspect, in a first possible implementation manner, the first determining unit includes a first determining module configured to determine a sensing region that is formed by sensing points whose capacitance difference is a negative value among all the sensing points as a first sensing region; a second determining module configured to determine a sensing region that is formed by sensing points whose capacitance difference is a positive value among all the sensing points as a second sensing region; and a third determining module configured to determine, according to a location relationship between the first sensing region and the second sensing region, the touch region on which the finger touch operation on the capacitive touchscreen acts.

With reference to the first possible implementation manner of the second aspect, in a second possible implementation manner, the third determining module is further configured to, if the first sensing region and the second sensing region are not connected, determine the first sensing region as the touch region on which the finger touch operation acts; and/or if the first sensing region and the second sensing region are connected and the first sensing region is surrounded by the second sensing region, determine a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

With reference to the first possible implementation manner of the second aspect, or the second possible implementation manner of the second aspect, in a third possible implementation manner, the electronic device further includes a second determining unit configured to determine the second sensing region as a water-covered region.

With reference to the first possible implementation manner of the second aspect, or the second possible implementation manner of the second aspect, or the third possible implementation manner of the second aspect, in a fourth possible implementation manner, the electronic device further includes a second acquiring unit configured to acquire an area of the second sensing region; and a control unit configured to control the electronic device to power off when the area of the second sensing region is larger than a preset area.

Based on a same disclosure concept, according to a third aspect, an electronic device is provided, including a capacitive touchscreen; and a processor, connected to the capacitive touchscreen and configured to acquire a current capacitance corresponding to each sensing point on a capacitive touchscreen of the electronic device; separately subtract a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen; and determine, according to the capacitance difference corresponding to each sensing point, a touch region on which a finger touch operation on the capacitive touchscreen acts.

With reference to the third aspect, in a first possible implementation manner, the processor is further configured to determine a sensing region that is formed by sensing points whose capacitance difference is a negative value among all the sensing points as a first sensing region; determine a sensing region that is formed by sensing points whose capacitance difference is a positive value among all the sensing points as a second sensing region; and determine, according to a location relationship between the first sensing region and the second sensing region, the touch region on which the finger touch operation on the capacitive touchscreen acts.

With reference to the first possible implementation manner of the third aspect, in a second possible implementation manner, the processor is further configured to, if the first sensing region and the second sensing region are not connected, determine the first sensing region as the touch region on which the finger touch operation acts; and/or if the first sensing region and the second sensing region are connected and the first sensing region is surrounded by the second sensing region, determine a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

With reference to the first possible implementation manner of the third aspect, or the second possible implementation manner of the third aspect, in a third possible implementation manner, the processor is further configured to determine the second sensing region as a water-covered region.

With reference to the first possible implementation manner of the third aspect, or the second possible implementation manner of the third aspect, or the third possible implementation manner of the third aspect, in a fourth possible implementation manner, the processor is further configured to acquire an area of the second sensing region; and control the electronic device to power off when the area of the second sensing region is larger than a preset area.

A capacitance corresponding to a sensing point decreases when there is a finger touch on the sensing point on a capacitive touchscreen, and the capacitance corresponding to the sensing point increases when there is water covering the sensing point. Therefore, in the embodiments of the present application, a capacitance difference corresponding to each sensing point is obtained by acquiring a current capacitance corresponding to each sensing point on the capacitive touchscreen of an electronic device, and separately subtracting a preset capacitance from the current capacitance corresponding to each sensing point, where the preset capacitance is a capacitance of any one of each sensing point when there is neither water nor a finger touch operation on the capacitive touchscreen; and a touch region on which the finger touch operation on the capacitive touchscreen acts is determined according to the capacitance difference corresponding to each sensing point. This effectively resolves a technical problem in the prior art, with an electronic device configured with a capacitive touchscreen, that the electronic device cannot recognize a finger touch region of a user when there is water on the surface of the capacitive touchscreen, and achieves a technical effect that the electronic device can still determine the touch region on which the finger touch operation acts when there is water on a surface of the capacitive touchscreen, so that a user can perform a normal touch operation on the capacitive touchscreen whose surface is covered by water.

### BRIEF DESCRIPTION OF DRAWINGS

FIG. 1A is a schematic diagram of a condition of capacitance differences corresponding to sensing points in a sensing region when there is a finger touch operation on the sensing region on a capacitive touchscreen according to Embodiment 1 of the present disclosure;

FIG. 1B is a schematic diagram of a condition of capacitance differences corresponding to sensing points in a sensing region when there is water covering the sensing region on a capacitive touchscreen according to Embodiment 1 of the present disclosure;

FIG. 1C is a schematic diagram of a condition of capacitance differences corresponding to sensing points in a water-covered sensing region and a finger-touched touch region, when there are both water and a finger touch operation on a capacitive touchscreen and the water-covered sensing region and the finger-touched touch region are not connected, according to Embodiment 1 of the present disclosure;

FIG. 1D is a schematic diagram of a condition of capacitance differences corresponding to sensing points in a water-covered sensing region and a finger-touched touch region, when there are both water and a finger touch operation on a capacitive touchscreen, and the water-covered sensing region and the finger-touched touch region are connected, and the finger-touched touch region is surround by the water-covered sensing region, according to Embodiment 1 of the present disclosure;

FIG. 2 is a schematic structural diagram of an electronic device according to Embodiment 2 of the present application;

FIG. 3 is a schematic structural diagram of an electronic device according to Embodiment 3 of the present application; and

FIG. 4 is a flowchart of an information processing method according to Embodiment 1 of the present disclosure.

### DESCRIPTION OF EMBODIMENTS

Embodiments of the present disclosure provide an information processing method and an electronic device, so as to resolve a technical problem in the prior art, with an electronic device configured with a capacitive touchscreen, that the electronic device cannot recognize a finger touch region of a user when there is water on a surface of the capacitive touchscreen.

To resolve the foregoing technical problem, a general idea of the technical solutions in the embodiments of the present application is as follows.

An information processing method includes acquiring a current capacitance corresponding to each sensing point on the capacitive touchscreen of the electronic device; separately subtracting a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen; and determining, according to the capacitance difference corresponding to each sensing point, a touch region on which a finger touch operation on the capacitive touchscreen acts.

A capacitance corresponding to a sensing point decreases when there is a finger touch on the sensing point on a capacitive touchscreen, and the capacitance corresponding to the sensing point increases when there is water covering the sensing point. Therefore, in the embodiments of the present application, the capacitance difference corresponding to each sensing point is obtained by acquiring the current capacitance corresponding to each sensing point on the capacitive touchscreen of the electronic device, and separately subtracting the preset capacitance from the current capacitance corresponding to each sensing point, where the preset capacitance is the capacitance of any one of all the sensing points when there is neither water nor a finger touch operation on the capacitive touchscreen; and the touch region on which the finger touch operation on the capacitive touchscreen acts is determined according to the capacitance difference corresponding to each sensing point. This effectively resolves a technical problem in the prior art, with an electronic device configured with a capacitive touchscreen, that the electronic device cannot recognize a finger touch region of a user when there is water on a surface of the capacitive touchscreen, and achieves a technical effect that the electronic device can still determine the touch region on which the finger touch operation acts when there is water on the surface of the capacitive touchscreen, so that a user can perform a normal touch operation on the capacitive touchscreen whose surface is covered by water.

To make the objectives, technical solutions, and advantages of the embodiments of the present application more clearly, the following clearly describes the technical solutions in the embodiments of the present application with reference to the accompanying drawings in the embodiments of the present application. The described embodiments are merely a part rather than all of the embodiments of the present application. All other embodiments obtained by a person of ordinary skill in the art based on the embodiments of the present application without creative efforts shall fall within the protection scope of the present disclosure.

It is noted first that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It is noted then that the “electronic device” in this specification may be a mobile phone, a tablet computer, a vehicle-mounted computer, a digital camera, a gaming console, or the like, and the electronic device is configured with a capacitive touchscreen.

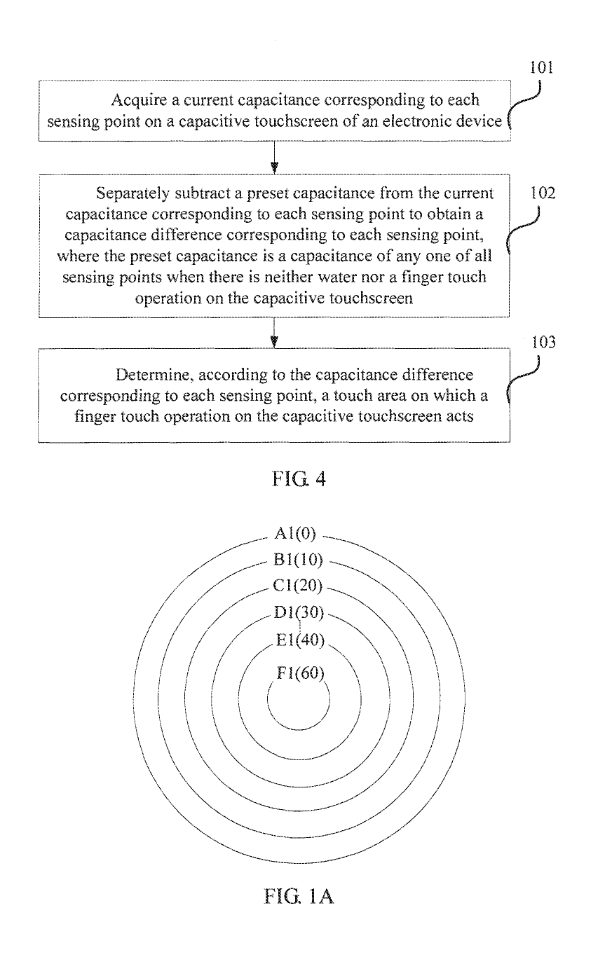

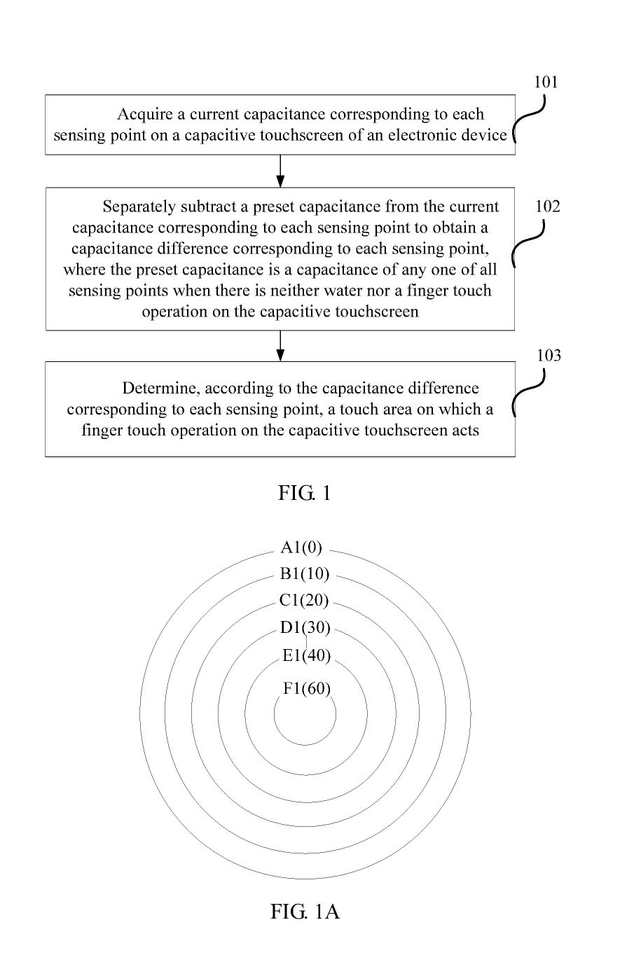

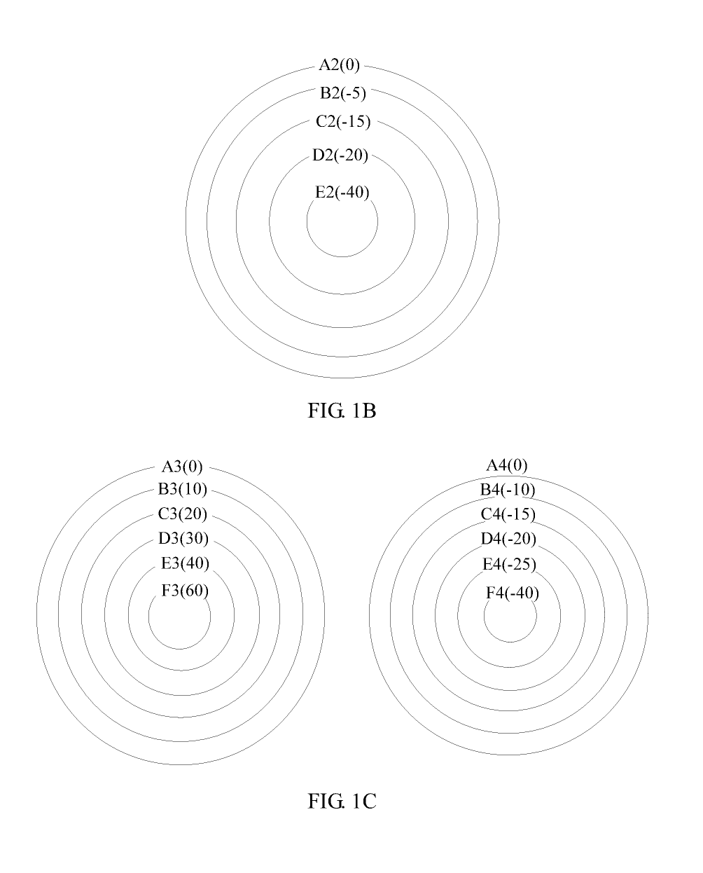

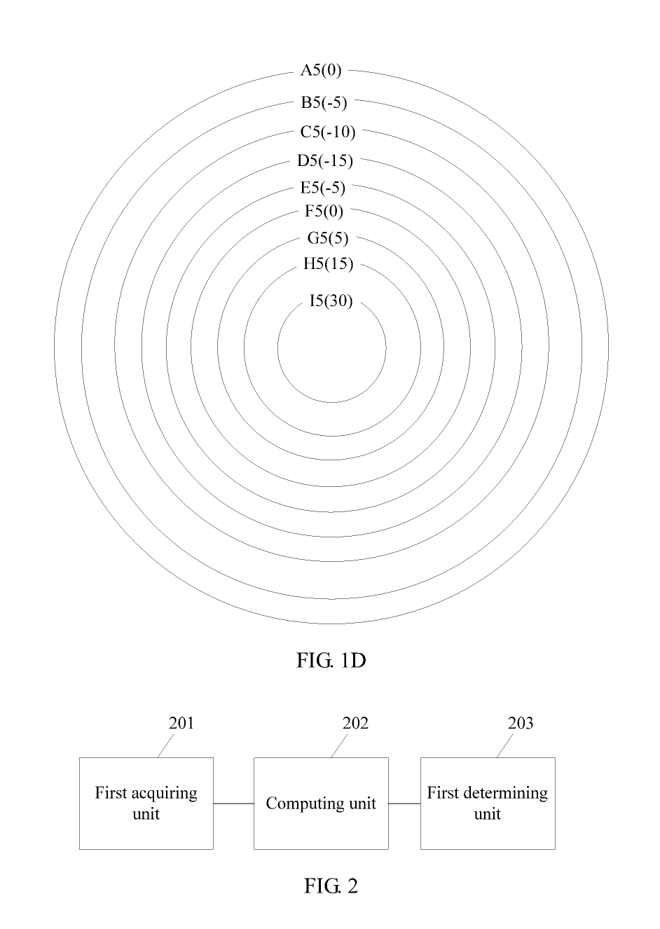

It is noted then that each closed curve represents a collection of sensing points whose capacitance differences are same on the capacitive touchscreen in FIG. 1A to FIG. 1D in the specification. A combination of a letter and a number outside a pair of brackets on each closed curve represents a corresponding closed curve. A number in the brackets that follows each letter represents a reference value of a current capacitance difference of a sensing point on the corresponding closed curve. The reference value is directly proportional to an actual capacitance difference. When the reference value is a positive value, the corresponding actual capacitance difference is also a positive value; when the reference value is a negative value, the corresponding actual capacitance difference is also a negative value; when the reference value is 0, the corresponding actual capacitance difference is also 0. For example, an outermost closed curve in FIG. 1A is described as a closed curve A1 and reference values of current capacitance differences corresponding to all sensing points on the closed curve A1 are 0; an innermost closed curve in FIG. 1A is described as a closed curve F1 and reference values of current capacitance differences corresponding to all sensing points on the closed curve F1 are 60. In addition, reference values of all sensing points on the sensing region outside a closed curve Ai (i is a positive integer smaller than 6) are 0.

### EMBODIMENT 1

The embodiment provides an information processing method. As shown in FIG. 4, the information processing method includes the following.

Step 101: Acquire a current capacitance corresponding to each sensing point on a capacitive touchscreen of an electronic device.

Step 102: Separately subtract a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen.

Step 103: Determine, according to the capacitance difference corresponding to each sensing point, a touch region on which a finger touch operation on the capacitive touchscreen acts.

As shown in FIG. 1A, FIG. 1A is a schematic diagram of a condition of reference values of capacitance differences of sensing points in a sensing region when there is a finger touch on the sensing region on a capacitive touchscreen. When there is a finger touch on a sensing region inside a closed curve A1, and for all sensing points inside the closed curve A1, a sensing point nearer to a center indicates a greater corresponding capacitance difference. For example, reference values of capacitance differences corresponding to the sensing points on the closed curve A1 are 0, but reference values of capacitance differences corresponding to sensing points on a closed curve F1 are 60. Generally, sensing points inside the closed curve F1 are sensing points touched by a central part of a finger pulp. It can be learned from FIG. 1A that when there is a finger touch on a sensing region on a capacitive touchscreen, capacitance differences of sensing points in the sensing region are all positive values.

Theoretically, when there is a finger touch on a sensing region on a capacitive touchscreen, reference values of capacitance differences corresponding to sensing points inside the sensing region are all positive values, and a sensing point nearer to a center indicates a greater corresponding capacitance difference. However, in fact, because there may be impurities on a finger and/or the touch region, error signals are generated, and the reference values of the capacitance differences corresponding to the sensing points in the region are inconsistent with theoretical values. In this case, these error signals should be filtered out.

In a specific implementation process, when there is a finger touch on a capacitive touchscreen, sensing points, in a touch region corresponding to a finger, corresponding to reference values of equal capacitance differences may be distributed in various many shapes, including but not limited to a circular ring shown in FIG. 1A, an ellipse, or another irregular closed curve.

More specifically, as shown in FIG. 1B, FIG. 1B is a schematic diagram of a condition of capacitance differences corresponding to sensing points in a sensing region when there is water covering the sensing region on a capacitive touchscreen. When there is water covering a sensing region inside a closed curve A2, and for all sensing points inside the closed curve A2, a sensing point nearer to a center indicates a smaller corresponding capacitance difference. For example, reference values of capacitance differences corresponding to the sensing points on the closed curve A2 are 0, but reference values of capacitance differences corresponding to sensing points on a closed curve E2 are −40. Generally, water on the sensing points inside the closed curve E2 is the thickest. It can be learned from FIG. 1B that when there is water covering a sensing region on a capacitive touchscreen, capacitance differences of sensing points in the sensing region are all negative values.

In a specific implementation process, when there is water on a capacitive touchscreen, reference values of capacitance differences corresponding to the sensing points on sensing region may be distributed in many shapes, which include but are not limited to a circular ring in FIG. 1B and may be an ellipse or another irregular closed curve.

Theoretically, when there is water covering a sensing region on a capacitive touchscreen, reference values of capacitance differences corresponding to sensing points inside the sensing region are all negative values, and a sensing point nearer to a center indicates a smaller corresponding capacitance difference. However, in fact, because there may be impurities on a finger and/or the touch region, error signals are generated, and the reference values of the capacitance differences corresponding to the sensing points in the region are inconsistent with theoretical values. In this case, these error signals should be filtered out.

A capacitance corresponding to a sensing point decreases when there is a finger touch on the sensing point on a capacitive touchscreen, and the capacitance corresponding to the sensing point increases when there is water covering the sensing point. Therefore, in this embodiment of the present application, the capacitance difference corresponding to each sensing point is obtained by acquiring the current capacitance corresponding to each sensing point on the capacitive touchscreen of the electronic device, and separately subtracting the preset capacitance from the current capacitance corresponding to each sensing point, where the preset capacitance is the capacitance of any one of all the sensing points when there is neither water nor a finger touch operation on the capacitive touchscreen; and the touch region on which the finger touch operation on the capacitive touchscreen acts is determined according to the capacitance difference corresponding to each sensing point. This effectively resolves a technical problem in the prior art, with an electronic device configured with a capacitive touchscreen, that the electronic device cannot recognize a finger touch region of a user when there is water on a surface of the capacitive touchscreen, and achieves a technical effect that the electronic device can still determine the touch region on which the finger touch operation acts when there is water on the surface of the capacitive touchscreen, so that a user can perform a normal touch operation on the capacitive touchscreen whose surface is covered by water.

In this embodiment of the present disclosure, optionally, the step 103 includes determining a sensing region that is formed by sensing points whose capacitance difference is a negative value among all the sensing points as a first sensing region; determining a sensing region that is formed by sensing points whose capacitance difference is a positive value among all the sensing points as a second sensing region; and determining, according to a location relationship between the first sensing region and the second sensing region, the touch region on which the finger touch operation on the capacitive touchscreen acts.

In a specific implementation process, as shown in FIG. 1C, reference values of capacitance differences corresponding to sensing points on a sensing region inside a closed curve A3 are all positive values, and therefore the sensing region inside the closed curve A3 is determined as the first sensing region; reference values of capacitance differences corresponding to sensing points on a sensing region inside a closed curve A4 are all negative values, and therefore the sensing region inside the closed curve A4 is determined as the second sensing region. If the first sensing region and the second sensing region are not connected, it is determined that there is a finger touch on the first sensing region (that is, the sensing region inside the closed curve A3).

In this embodiment of the present disclosure, optionally, the information processing method further includes, if the first sensing region and the second sensing region are not connected, determining the first sensing region as the touch region on which the finger touch operation acts; and/or if the first sensing region and the second sensing region are connected and the first sensing region is surrounded by the second sensing region, determining a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

In a specific implementation process, as shown in FIG. 1D, reference values of capacitance differences corresponding to all sensing points on a sensing region between a closed curve A5 and a closed curve F5 are all negative values, and therefore the sensing region between the closed curve A5 and the closed curve F5 is determined as the second sensing region; reference values of capacitance differences corresponding to sensing points on a sensing region inside the closed curve F5 are all positive values, and therefore the sensing region inside the closed curve F5 is determined as the first sensing region. Because the first sensing region is surrounded by the second sensing region, a sensing region inside a closed curve D5 is determined as the third sensing region, and it is determined that there is a finger touch on the third sensing region, where sensing points on the closed curve D5 are sensing points corresponding to an inflection point at which the capacitance difference turns from a decreasing trend to an increasing trend.

In this embodiment of the present disclosure, optionally, the information processing method further includes determining the second sensing region as a water-covered region. As shown in FIG. 1C, the sensing region inside the closed curve A4 may be determined as a water-covered region; as shown in FIG. 1D, the sensing region between the closed curve A5 and the closed curve F5 may be determined as a water-covered region.

In this embodiment of the present disclosure, optionally, the information processing method further includes acquiring an area of the second sensing region; and controlling the electronic device to power off when the area of the second sensing region is larger than a preset area.

In a specific implementation process, a size of the preset area ranges from 50% to 80% of a total area of the capacitive touchscreen. When it is determined that the area of the second sensing region is larger than the a preset area, it may be determined that the electronic device falls into water (or that there is plenty of water covering the touchscreen of the electronic device). In this case, to prevent water from entering the inside of the electronic device and therefore causing damage to other electronic components (such as a main board, a central processing unit (CPU), and a memory), the electronic device is controlled to power off.

### EMBODIMENT 2

Based on a same disclosure concept, as shown in FIG. 2, an embodiment of the present disclosure provides an electronic device, including a first acquiring unit 201 configured to acquire a current capacitance corresponding to each sensing point on a capacitive touchscreen of the electronic device; a computing unit 202 configured to receive the current capacitance corresponding to each sensing point from the first acquiring unit 201, and separately subtract a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen; and a first determining unit 203 configured to receive the capacitance difference corresponding to each sensing point from the computing unit 202, and determine, according to the capacitance difference corresponding to each sensing point, a touch region on which a finger touch operation on the capacitive touchscreen acts.

In this embodiment of the present disclosure, optionally, the first determining unit 203 includes a first determining module configured to determine a sensing region that is formed by sensing points whose capacitance difference is a negative value among all the sensing points as a first sensing region; a second determining module configured to determine a sensing region that is formed by sensing points whose capacitance difference is a positive value among all the sensing points as a second sensing region; and a third determining module configured to determine, according to a location relationship between the first sensing region and the second sensing region, the touch region on which the finger touch operation on the capacitive touchscreen acts.

In this embodiment of the present disclosure, optionally, the third determining module is further configured to, if the first sensing region and the second sensing region are not connected, determine the first sensing region as the touch region on which the finger touch operation acts; and/or if the first sensing region and the second sensing region are connected and the first sensing region is surrounded by the second sensing region, determine a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

In this embodiment of the present disclosure, optionally, the electronic device further includes a second determining unit configured to determine the second sensing region as a water-covered region. In this embodiment of the present disclosure, optionally, the electronic device further includes a second acquiring unit configured to acquire an area of the second sensing region; and a control unit configured to control the electronic device to power off when the area of the second sensing region is larger than a preset area.

### EMBODIMENT 3

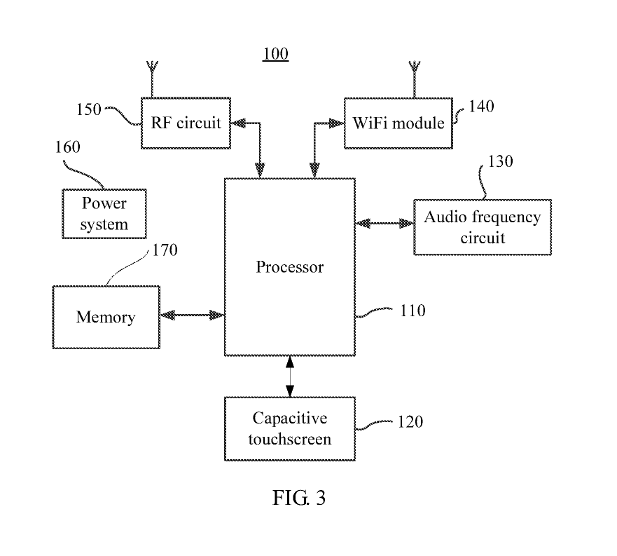

Based on a same disclosure concept, as shown in FIG. 3, an embodiment of the present disclosure provides an electronic device 100, including a capacitive touchscreen 120, where, as an input apparatus of the electronic device 100, the capacitive touchscreen 120, based on a capacitive sensing technology, can sense a capacitive change corresponding to a touch region generated by a finger touch, so as to determine a touch region of a finger, so that a user can, based on the capacitive touchscreen 120, implement man-machine interaction with the electronic device 100; and in addition, as a display apparatus of the electronic device, the capacitive touchscreen 120 can display visual output to the user, where the visual output may include a text, an image, a video, and any combination thereof; a processor 110, connected to the capacitive touchscreen 120 and configured to acquire a current capacitance corresponding to each sensing point on the capacitive touchscreen 120 of the electronic device 100; separately subtract a preset capacitance from the current capacitance corresponding to each sensing point to obtain a capacitance difference corresponding to each sensing point, where the preset capacitance is a capacitance of any one of each sensing point when there is neither water nor a finger touch operation on the capacitive touchscreen 120; and determine, according to the capacitance difference corresponding to each sensing point, a touch region on which a finger touch operation on the capacitive touchscreen 120 acts.

In this embodiment of the present disclosure, optionally, the processor 110 is further configured to determine a sensing region that is formed by sensing points whose capacitance difference is a negative value among all the sensing points as a first sensing region; determine a sensing region that is formed by sensing points whose capacitance difference is a positive value among all the sensing points as a second sensing region; and determine, according to a location relationship between the first sensing region and the second sensing region, the touch region on which the finger touch operation on the capacitive touchscreen acts.

In this embodiment of the present disclosure, optionally, the processor 110 is further configured to, if the first sensing region and the second sensing region are not connected, determine the first sensing region as the touch region on which the finger touch operation acts; and/or if the first sensing region and the second sensing region are connected and the first sensing region is surrounded by the second sensing region, determine a third sensing region that is surrounded by a first group of sensing points in the second sensing region as the touch region on which the finger touch operation acts, where the first group of sensing points are sensing points corresponding to an inflection point at which the capacitance difference turns from a decreasing trend to an increasing trend.

In this embodiment of the present disclosure, optionally, the processor 110 is further configured to determine the second sensing region as a water-covered region.

In this embodiment of the present disclosure, optionally, the processor 110 is further configured to acquire an area of the second sensing region; and control the electronic device to power off when the area of the second sensing region is larger than a preset area.

In this embodiment of the present disclosure, optionally, the electronic device 100 further includes a memory 170, connected to the processor 110, which may include a high-speed random access memory, and may further include a non-volatile memory, for example, one or more disk storage devices, flash memory devices or other non-volatile solid state storage devices. In some embodiments, the memory 170 may further include one or more memories far away from the processor 110, such as a network-attached storage accessed by a communications network (not shown), where the communications network may be the Internet, one or more intranets, local area networks, wide area networks, or storage area networks, or an appropriate combination thereof

In this embodiment of the present disclosure, optionally, the electronic device 100 further includes: a radio frequency (RF) circuit 150, connected to the processor 110 and configured to receive and send an electromagnetic wave. The RF circuit 150 converts an electrical signal into an electromagnetic wave, or converts an electromagnetic wave into an electrical signal, and communicates with the communications network and another communications device using an electromagnetic wave. The RF circuit 150 may include known circuits that are configured to execute these functions, including but not limited to an antenna system, an RF transceiver, one or more amplifiers, a tuner, one or more oscillators, a digital signal processor, and a memory. The RF circuit 150 may communicate with a network or another device by means of wireless communication, where the network may be the Internet that is referred to as the World Wide Web, an intranet, and/or a wireless network such as a cellular network or a wireless local area network.

In this embodiment of the present disclosure, optionally, the electronic device 100 further includes a WIFI module 140, connected to the processor 110 and configured to communicate with an access network by means of a WIFI signal.

In this embodiment of the present disclosure, optionally, the electronic device 100 further includes an audio frequency circuit 130, connected to the processor 110, including a loudspeaker, a microphone, and an audio interface between a user and the electronic device 100. The audio frequency circuit 130 receives audio data from the processor 110, converts the audio data into an electrical signal, and transfers the electrical signal to the loudspeaker. The loudspeaker converts the electrical signal into a sound wave audible to human ear. The audio frequency circuit 130 further receives an electrical signal converted by the microphone from the sound wave. The audio frequency circuit 130 converts the electrical signal into audio data, and transfers the audio data to the processor 110 for processing.

In this embodiment of the present disclosure, optionally, the electronic device 100 further includes a power system 160, where the power system 160 may include a power management system, one or more power supplies (such as a battery, an alternating current, a charging system, a power failure detection circuit, a power converter or inverter, a power status indicator, and any other components that are related to power generation, management, and distribution of a portable device.)

Obviously, a person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

1. An information processing method, comprising:
acquiring a current capacitance corresponding to each sensing point on a capacitive touchscreen of an electronic device;
separately subtracting a preset capacitance from the current capacitance corresponding to each sensing point to obtain a capacitance difference corresponding to each sensing point, wherein the preset capacitance is a capacitance of any one of each sensing point when there is neither water nor a finger touch operation on the capacitive touchscreen; and
determining, according to the capacitance difference corresponding to each sensing point, a touch region on which a finger touch operation on the capacitive touchscreen acts.

2. The method according to claim 1, wherein the determining, according to the capacitance difference corresponding to each sensing point, a touch region on which a finger touch operation on the capacitive touchscreen acts comprises:
determining a sensing region that is formed by sensing points whose capacitance difference is a negative value among all the sensing points as a first sensing region;
determining a sensing region that is formed by sensing points whose capacitance difference is a positive value among all the sensing points as a second sensing region; and
determining, according to a location relationship between the first sensing region and the second sensing region, the touch region on which the finger touch operation on the capacitive touchscreen acts.

3. The method according to claim 2, wherein the determining, according to a location relationship between the first sensing region and the second sensing region, the touch region on which the finger touch operation on the capacitive touchscreen acts comprises:
determining the first sensing region as the touch region on which the finger touch operation acts when the first sensing region and the second sensing region are not connected; and
determining a third sensing region that is surrounded by a first group of sensing points in the second sensing region as the touch region on which the finger touch operation acts when the first sensing region and the second sensing region are connected and the first sensing region is surrounded by the second sensing region, wherein the first group of sensing points are sensing points corresponding to an inflection point at which the capacitance difference turns from a decreasing trend to an increasing trend.

4. The method according to claim 2, wherein the method further comprises: determining the second sensing region as a water-covered region.

5. The method according to claim 2, wherein the method further comprises:
acquiring an area of the second sensing region; and
controlling the electronic device to power off when the area of the second sensing region is larger than a preset area.

6. An electronic device, comprising:
a first acquiring unit configured to acquire a current capacitance corresponding to each sensing point on a capacitive touchscreen of the electronic device;
a computing unit coupled to the first acquiring unit and configured to:
receive the current capacitance corresponding to each sensing point from the first acquiring unit; and
separately subtracting a preset capacitance from the current capacitance corresponding to each sensing point to obtain a capacitance difference corresponding to each sensing point, wherein the preset capacitance is a capacitance of any sensing point when there is neither water nor a finger touch operation on the capacitive touchscreen; and
a first determining unit coupled to the computing unit and configured to:
receive the capacitance difference corresponding to each sensing point from the computing unit; and
determine, according to the capacitance difference corresponding to each sensing point, a touch region on which a finger touch operation on the capacitive touchscreen acts.

7. The electronic device according to claim 6, wherein the first determining unit comprises:
a first determining module configured to determine a sensing region that is formed by sensing points whose capacitance difference is a negative value among all the sensing points as a first sensing region;
a second determining module configured to determine a sensing region that is formed by sensing points whose capacitance difference is a positive value among all the sensing points as a second sensing region; and
a third determining module configured to determine, according to a location relationship between the first sensing region and the second sensing region, the touch region on which the finger ouch operation on the capacitive touchscreen acts.

8. The electronic device according to claim 7, wherein the third determining module is further configured to:
determine the first sensing region as the touch region on which the finger touch operation acts when the first sensing region and the second sensing region are not connected; and
determine a third sensing region that is surrounded by a first group of sensing points in the second sensing region as the touch region on which the finger touch operation acts when the first sensing region and the second sensing region are connected and the first sensing region is surrounded by the second sensing region, and wherein the first group of sensing points are sensing points corresponding to an inflection point at which the capacitance difference turns from a decreasing trend to an increasing trend.

9. The electronic device according to claim 7, wherein the electronic device further comprises: a second determining unit configured to determine the second sensing region as a water-covered region.

10. The electronic device according to claim 7, wherein the electronic device further comprises:
a second acquiring unit configured to acquire an area of the second sensing region; and
a controller configured to control the electronic device to power off when the area of the second sensing region is larger than a preset area.

11. An electronic device, comprising:
a capacitive touchscreen; and
a processor connected to the capacitive touchscreen and configured to:
acquire a current capacitance corresponding to each sensing point on a capacitive touchscreen of the electronic device;
separately subtract a preset capacitance from the current capacitance corresponding to each sensing point to obtain a capacitance difference corresponding to each sensing point, wherein the preset capacitance is a capacitance of any sensing point when there is neither water nor a finger touch operation on the capacitive touchscreen; and
determine, according to the capacitance difference corresponding to each sensing point, a touch region on which a finger touch operation on the capacitive touchscreen acts.

12. The electronic device according to claim II, wherein the processor is further configured to:
determine a sensing region that is formed by sensing points whose capacitance difference is a negative value among all the sensing points as a first sensing region;
determine a sensing region that is formed by sensing points whose capacitance difference is a positive value among all the sensing points as a second sensing region; and
determine, according to a location relationship between the first sensing region and the second sensing region, the touch region on which the finger touch operation on the capacitive touchscreen acts.

13. The electronic device according to claim 12, wherein the processor is further configured to:
determine the first sensing region as the touch region on which the finger touch operation acts when the first sensing region and the second sensing region are not connected; and
determine a third sensing region that is surrounded by a first group of sensing points in the second sensing region as the touch region on which the finger touch operation acts when the first sensing region and the second sensing region are connected and the first sensing region is surrounded by the second sensing region, wherein the first group of sensing points are sensing points corresponding to an inflection point at which the capacitance difference turns from a decreasing trend to an increasing trend.

14. The electronic device according to claim 12, wherein the processor is further configured to determine the second sensing region as a water-covered region.

15. The electronic device according to claim 12, wherein the processor is further configured to:
acquire an area of the second sensing region; and
control the electronic device to power off when the area of the second sensing region is larger than a preset area.
